(19) United States
(12) Patent Application Publication
(10) Pub. No.: US 2005/0281991 A1
(43) Pub. Date: Dec. 22, 2005

(54) CUSTOMIZED TEMPORARY TATTOO KIT

(76) Inventors: Barbara Funke, Northville, MI (US); Roxanne Donatiello, Northville, MI (US)

Correspondence Address: ARTZ & ARTZ, P.C., 28333 TELEGRAPH RD., SUITE 250, SOUTHFIELD, MI, 48034, US

(21) Appl. No.: 11/160,301

(22) Filed: Jun. 17, 2005

Related U.S. Application Data
(60) Provisional application No. 60/581,286, filed on Jun. 18, 2004.

(51) Int. Cl. B32B 9/00

(52) U.S. Cl. 428/195.1

(57) ABSTRACT

A temporary tattoo for placement on an individual's skin includes a first portion and a second portion. The first portion and the second portion have different images thereon. When the first portion and the second portion are combined they form a complete image.

### CROSS-REFERENCE TO RELATED APPLICATIONS

The present application claims priority from U.S. Provisional Application Ser. No. 60/581,286, filed Jun. 18, 2004 and entitled “Customized Temporary Tattoo Kit.”

### TECHNICAL FIELD

The present invention relates generally to a temporary tattoo containing an image for application to an individual's skin. More particularly, the present invention relates to a temporary tattoo kit for application to an individual's skin that contains various interchangeable or substitutable portions.

### BACKGROUND OF THE INVENTION

Decoration of the human body has been commonplace in most human cultures. Societies from the most primitive in technological development to the most sophisticated by today's standards tolerate, if not promote, such decoration. The first efforts at adorning the human body were generally believed to involve the use of clays and ash to add coloration to the human body. The use of stains or dyes from flora was also used early in the development of primitive societies. These types of adornment were used for various purposes including recognition of status, signaling of marital intent or status, enhancing attractiveness to suitors, providing religious and ceremonial markings, and creation of a fearsome or frightening visage.

A tattoo is one such way of decorating a human body and today is one of the most common ways of accomplishing skin decoration. A tattoo can be either permanent or non-permanent. Permanent tattoos are well known and have their origins dating back to at least as the early Egyptian times. Permanent tattoos are typically applied to the skin with tattoo needles, which ink a desired design onto an individual's skin. Non-permanent or temporary tattoos are also known, and are typically adhered to an individual's skin in a variety of known fashions. Tattoos have been applied to an individual's skin for a variety of different purposes, including decoration, social status, and as a sign of endearment.

Three primary types of temporary tattoos or tattoo imitations have been developed to give the appearance of detailed skin or body images without the permanency or pain involved with permanent tattoos. The three major types of substitutes include transferable dye images, painted images, and decal images. Each of these images is placed on the skin by different methods, including by wetting the image and transferring it or securing it to the skin through an adhesive.

The design and production of small size illustrations, originally known as “scraps,” that the end user sticks onto something else dates back at least to Victorian times. In the earlier part of the Nineteenth Century, the scraps would be cut-out by hand and applied separately, such as with glue, similar to early postage stamps. With advances in the manufacture of paper and development of color printing, embossing and die-cutting, sticking scraps into scrapbooks onto folding screens and other objects became a popular pastime, particularly among children. Many examples of their efforts have survived.

These “scraps” were the equivalent to the modern day stickers, with the scraps being placed in a scrapbook. Currently, the sticker business is popular, particularly with children. Sheets of stickers depicting images from cartoons or movies of other shows or items directed to children are readily available. These stickers can be placed in sticker books. Similarly, instead of stickers, the same and other images are also available in the form of a temporary tattoo that can be applied to a user's skin, such as a child. These temporary tattoos all come as a single unitary piece and can be applied by a variety of different methods. Further, the design on these temporary tattoos cannot be changed.

One popular children's hobby involves the field of paper doll images. Paper dolls are often comprised of cut-outs of human figures, adults, and children of both sexes that can be dressed in separately provided outfits tailored to conceal whatever clothing is incorporated into the illustration—usually simple underwear. Stickers in the form of accessories, such as clothing etc., are available for application to the paper doll images. This allows a child to dress the figures in clothing and accessorize them as well as to allow the child to change the clothing and accessories as desired. While this concept is available in stickers, similar concepts are also available in other forms, including felt, paper, magnetic form, and the like.

While these hobbies and stickers are all suitable for their intended purpose they all suffer from application specific limitations.

### SUMMARY OF THE INVENTION

It is therefore an advantage of the present invention to provide a temporary tattoo for application to an individual's skin that contains multiple components.

It is another advantage of the present invention to provide a temporary tattoo for application to an individual's skin that comes in a kit with multiple interchangeable components.

It is a further advantage of the present invention to provide a temporary tattoo for application to an individual's skin that consists of various images popular with today's youth or any other age.

It is still another advantage of the present invention to provide a temporary tattoo for application to an individual's skin that consists of multiple layers positioned one on top of the other.

It is still a further advantage of the present invention to provide a temporary tattoo for application to an individual's skin that consists of a kit of multiple different pieces to be assembled and applied to an individual's skin as a single component.

It is yet another advantage of the present invention to provide a temporary tattoo for application to an individual's skin that consists of multiple pieces positioned to align with one another in a side-by-side or edge-to edge relationship.

In accordance with the above and other advantages of the present invention, a temporary tattoo for placement on an individual's skin is provided. The temporary tattoo consists of a first base figure layer that is applied directly to the skin. The temporary tattoo also includes at least one top layer that is positioned on top of the base figure layer.

The present invention further includes a temporary tattoo consisting of multiple portions for application to an individual's skin. In another embodiment, the temporary tattoo consists of a head portion having particular facial characteristics. The temporary tattoo also includes an upper body portion having a particular type of upper body garments and accessories thereon. The temporary tattoo further includes a lower body portion with a particular type of lower body garments. These portions are disposed side-by-side (edge-to-edge) or can be sewed to one another with a securing mechanism.

The present invention also includes a temporary tattoo kit including a base figure layer and a plurality of potions that are intended to be disposed on top of the base figure layer. In one embodiment, the base figure layer is a doll that is intended to be placed on an individual's skin. The plurality of portions are clothing and other accessories for the doll that are intended to be positioned on top of the base figure layer. The plurality of portions can be disposed on top of the base figure layer before or after the base figure layer has been applied to the skin.

These and other features and advantages of the present invention will become apparent from the following description of the invention, when viewed in accordance with the accompanying drawings and appended claims.

### BRIEF DESCRIPTION OF THE DRAWINGS

FIG. 1 is a schematic illustration of a base figure for a temporary tattoo in accordance with one embodiment of the present invention.

FIG. 2A is a schematic illustration of one accessory for a temporary tattoo in accordance with one embodiment of the present invention.

FIG. 2B is a schematic illustration of another accessory for a temporary tattoo in accordance with one embodiment of the present invention.

FIG. 2C is a schematic illustration of still another accessory for a temporary tattoo in accordance with one embodiment of the present invention.

FIG. 2D is a schematic illustration of yet another accessory for a temporary tattoo in accordance with one embodiment of the present invention.

FIG. 2E is a schematic illustration of a further accessory for a temporary tattoo in accordance with one embodiment of the present invention.

FIG. 2F is a schematic illustration of still a further accessory for a temporary tattoo in accordance with one embodiment of the present invention.

FIG. 2G is a schematic illustration of yet a further accessory for a temporary tattoo in accordance with one embodiment of the present invention.

FIG. 3 is a schematic illustration of a completed customized temporary tattoo in accordance with the present invention.

### DETAILED DESCRIPTION OF THE PREFERRED EMBODIMENT(S)

The present invention discloses various embodiments of a temporary tattoo for application to an individual's skin for decorative purposes. In one embodiment, the proposed concept involves a temporary tattoo for application to an individual's skin that utilizes a model similar to that employed by paper dolls. While the term dolls is utilized herein, the concept may be embodied with dolls, characters, dogs, men, women, children, birds, horses, cats, and/or a variety of other known people or animals, including celebrities. Additionally, a variety of other animate or inanimate objects may also be utilized. The disclosed exemplary embodiment utilizes a base figure consisting of one or more of the above persons, animals, or objects.

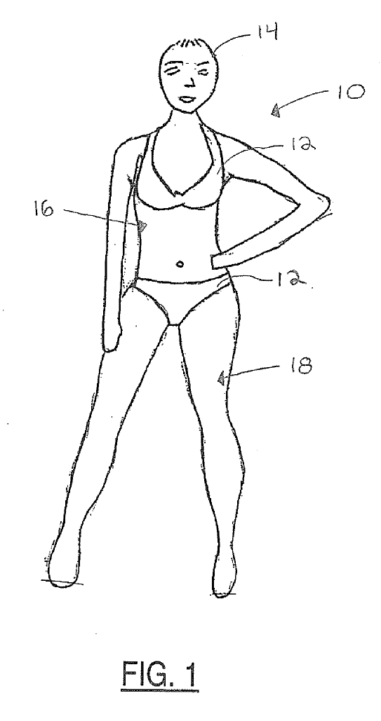

As shown in FIG. 1, the base FIG. 10 may contain no clothing or may contain undergarments 12. It will be understood that the base FIG. 10 may contain a variety of different amounts of clothing. In another embodiment, the base FIG. 10 includes clothing and different accessories, including jewelry, shoes, hats necklaces, finger nails, different types of clothing and clothing accessories and the like. In one embodiment, the temporary tattoo preferably comes in a kit, which includes a base figure and some accessories to be applied over top of the base FIG. 10, as discussed in more detail below.

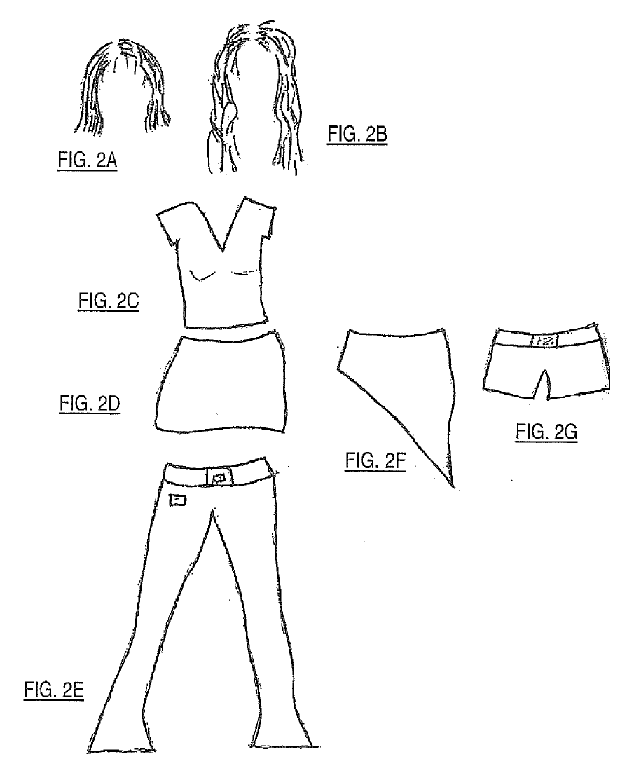

FIGS. 2A and 2B illustrate exemplary hair type adornments that can be applied over the base FIG. 10. For example, FIG. 2A illustrates a hair adornment consisting of shorter hair to be applied over the head portion 14 of the base FIG. 10. FIG. 2B illustrates another hair adornment consisting of longer hair to be applied over the head portion 14 of the base FIG. 10. It will be understood that the hair may come in a variety of different lengths. Indeed, a bald head adornment may also be utilized. Further, the hair adornment may come in a variety of different colors, i.e. blonde, red, brown, black or multi-colored. Moreover, the hair adornment may come in a variety of different styles as will be understood by one of ordinary skill in the art.

FIG. 2C through 2G illustrate exemplary clothing adornments that can be applied over the base FIG. 10. For example, FIG. 2C illustrates an exemplary top for application over top of an upper body portion 16 of the base FIG. 10. Obviously, a variety of other top clothing adornments for application to the upper body portion 16 can be employed, including tank tops, long sleeve shirts, tee-shirts, dresses or the like. FIGS. 2D through 2G illustrate exemplary bottoms for application to a lower body portion 18 of the base FIG. 10. FIG. 2D illustrates a skirt for application over the base FIG. 10. FIG. 2E illustrates a pair of pants for application over the base FIG. 10. FIG. 2F illustrates another skirt for application over the base FIG. 10. FIG. 2G illustrates a pair of shorts for application over the base figure. It will be understood that a variety of different bottoms for application to the lower body portion 18 may be utilized. Further, accessories, such as belts, pockets, and scarves may be incorporated into the bottoms or tops or may be separate components to be applied over the base FIG. 10.

In yet another embodiment, the tattoo comes as a kit, which includes the base FIG. 10 having a blank face. The kit also includes various face parts, such as eyes, noses, ears, etc. It will be understood by one of ordinary skill of the art that the kit can include a variety of different types and amounts of face parts. The kit can also include body parts (if human), feathers (if a bird), and other animal specific outer components. Thus, in operation, once a kit has been purchased, an individual can place a base figure on the skin. Thereafter, the individual can chose various accessories, including face accessories and clothing to place over the base figure, such that the final temporary tattoo meets an individual's desires and needs. Obviously, the accessories may alternatively be placed on the base figure prior to application to the skin or instead of a kit and entire pre-assembled tattoo can be purchased. The temporary tattoo is preferably applied by wetting them and then applying them to the skin.

It will be understood that these temporary tattoo dolls, dogs, horses, women, men, children, characters (theme) may be intermingled together or offered independently from one another. For example, portions may be offered together such that a woman and horse could be sold together to allow an individual to place a woman riding a horse on their skin. Other non-exhaustive examples include a man walking his dog or a child with a parrot on their shoulder.

By further way of example, a kit in accordance with one preferred embodiment can include a blank faced dog, a human, a television or move character, a movie star, a cat or the like. Additional face pieces may be offered. Further, additional accessories may be offered for embellishment in the kit or may be available individually. The kit may also include coordinating people, kids, characters, movie stars with any of the other characters, horses, dogs, birds, etc. As set forth above, the kits may include a blank face or a completed face along with the accessories.

In one embodiment, the kit includes a base figure. The base figure includes a face, but no clothes. However, the kit comes with additional accessories, such as clothes, shoes, jewels/jewelry, hair, eyes, and the like. Other accessories may include earrings, necklaces, anklets, toe rings, bracelets, and rings. However, a variety of other accessories may also be utilized. In yet another embodiment, the doll, animal, character, clothing and/or accessories may be obtained in “sections”.

In still yet another embodiment, instead of a full body with accessories to attach, the kit may include sections of a full body such as a lower body, an upper body and a head which are laid next to one another with one edge lying adjacent another edge, i.e. side-by-side or edge-to-edge. Alternatively, the separate portions can be secured to one another by adhesive or by another securing mechanism such as through interconnecting like a puzzle. These upper body and lower body portions, for example, may already have adornments prior to application to an individual's skin. For example, a kit may include a couple of head/faces, a couple of upper bodies clothed and/or jeweled, a mid section clothed, belts and/or accessories, and lower section skirt, pants, shoes, jewels etc/surf board/brief case/skate board. This would allow an individual to complete the doll as a whole, and could choose how to piece it together. This avoids overlapping in this method. Still a paper doll concept, this eliminates a need to overlap materials. In this embodiment, the lack of the portions can include a grid or outline to assist in aligning these components onto the skin.

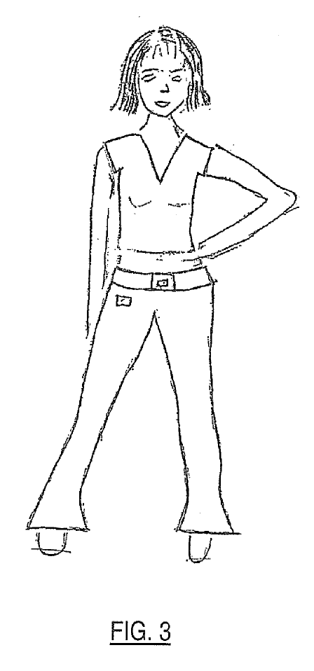

A break down for an exemplary kit would include (1) two face choices, finished or not, with earrings, hair, make-up etc., (2) two upper body parts with arms, top, jewels etc., (3) two lower body choices with clothes, jewels, etc., and (4) shoes may or may not be included with lower body portion/may be alone. This kit may have additional accessories such as for example surf board, skate board, etc. The resultant combination of these features is shown for example in FIG. 3. This kit may be offered on one sheet or in separate pieces. This kit may include matching jewelry for the user, as well as possible jewels to apply to the doll. This is “not” limited to people. This can apply to any and all prior characters, animals, male, female, movie star, etc.

Instead of generic clothing, the kits may include brand name clothing lines, jewelry lines, breed specific animals, people of different ethnicities, brand name dolls, name brand shoes, purses, and hats, etc. Any of the accessories may be brand name or generic.

In a preferred embodiment, the temporary tattoo consists of multiple temporary tattoos layered on top of one another to create a customized temporary tattoo. The tattoo can be a customized paper doll, a person, an animal, a character, etc. The temporary tattoos may be applied by known method, such as through an adhesive. Alternatively, the temporary tattoo or at least portions thereof may be applied in a liquid form.

Other examples of a temporary tattoo in accordance with the present invention include a glass, such as a martini glass, with the kit including an olive and a stick. The martini kit may also include liquid for the glass, which may be glow in the dark, as well as decorations for the glass. As yet another example, the kits may include Holiday paraphernalia, such as a Christmas hat, a top hat, a New Year horn, bunny ears, bandana, bow tie, accessories, etc.

Having now fully described the invention, it will be apparent to one of ordinary skill in the art that many changes and modifications can be made thereto without departing from the spirit or scope of the invention as set forth herein.

1. A temporary tattoo for application to an individual's skin, comprising:
a first portion having a predetermined portion of a full image thereon for application to the individual's skin;
a second portion having another predetermined portion of said full image thereon for application to the individual's skin;
said second portion is intended to align with said first portion such that said first portion and said second portion form a said full image.

2. The temporary tattoo of claim 1, wherein said first portion consists of a base layer that generally corresponds to a human figure.

3. The temporary tattoo of claim 2, wherein said second portion consists of a clothing adornment for application over said base layer.

4. The temporary tattoo of claim 3 further comprising a plurality of clothing adornments and/or accessories for application over said base layer such that the resulting temporary tattoo consists of a clothed and accessorized person.

5. The temporary tattoo of claim 1, wherein said first portion consists of a head portion of a human figure.

6. The temporary tattoo of claim 5, wherein said second portion consists of a body portion of a human figure that is intended to align with said first portion.

7. The temporary tattoo of claim 5, further comprising:
a third portion having a predetermined image thereon for application to the individual's skin and
wherein said third portion consists of a leg portion of a human being that is intended to align with said second portion.

8. The temporary tattoo of claim 6, wherein said first portion and said second portion have an interlocking mechanism to keep them properly aligned with respect to one another.

9. A temporary tattoo for application to an individual's skin, compromising:
a base layer for application directly to an individual's skin;
a plurality of images for placement overtop of said base layer;
wherein said plurality images and said base layer form a completed image;
wherein said plurality of images are interchangeable.

10. The temporary tattoo of claim 9, wherein said base layer has the form of a human figure.

11. The temporary tattoo of claim 10, wherein said plurality of images are selected from clothing, hair, facial features and accessories.

12. The temporary tattoo of claim 9, wherein said base layer has the form of an animal.

13. The temporary tattoo of claim 9, wherein said base layer has the form of an inanimate object.

14. A temporary tattoo for application to an individual's skin, comprising:
a top portion having an image thereon for application to the individual's skin;
a bottom portion having an image thereon for application to the individual's skin;
wherein said top portion is intended to align with said bottom portion to form a larger image;
wherein said top portion and said bottom portions have an attachment mechanism to keep them engaged and in alignment.

15. The temporary tattoo of claim 14, wherein said top portion takes the form of a human head and torso, including arms and hands.

16. The temporary tattoo of claim 15, wherein said bottom portion takes the shape human legs and feet.

17. The temporary tattoo of claim 15 further comprising:
a plurality of top portions having different images thereon; and
a plurality of bottom portions having different images thereon;
wherein said plurality of top portions and said plurality of bottom portions are interchangeable to provide different images.

18. The temporary tattoo of claim 17, wherein said top portion takes the form of a human head and torso, including arms and hands and have different predetermined facial features and clothing thereon.

19. The temporary tattoo of claim 17, wherein said bottom portions take the form of human legs and feet and have different predetermined clothing adornments thereon.
